(19) United States
(12) Patent Application Publication
(10) Pub. No.: US 2025/0283783 A1
(43) Pub. Date: Sep. 11, 2025

(54) FAULT SYMPTOM DIAGNOSTIC SYSTEM AND FAULT SYMPTOM DIAGNOSTIC METHOD

(71) Applicant: HONDA MOTOR CO., LTD., Tokyo (JP)

(72) Inventors: Masayuki Sadakiyo, Wako-shi (JP); Shuji Kawano, Wako-shi (JP)

(21) Appl. No.: 19/010,909

(22) Filed: Jan. 6, 2025

(30) Foreign Application Priority Data
Mar. 8, 2024 (JP) 2024-035509

(51) Int. Cl. G01M 13/045; G01M 13/021

(52) U.S. Cl. CPC G01M 13/045; G01M 13/021

(57) ABSTRACT

A fault symptom diagnostic system includes a fault symptom recognition unit configured to recognize a fault symptom of a component of a movable unit. The fault symptom recognition unit executes first monitoring processing of repeatedly executing acoustic emission measuring processing and determining whether or not a first determination condition under which a number of times of detecting acoustic emission waves is equal to or larger than a predetermined number of times of determination is established, and when the first determination condition is established, ends the first monitoring processing and executes second monitoring processing of repeatedly executing vibration measuring processing of acquiring vibration detection information by a vibration detection information acquisition unit and recognizing a vibration level of the component based on vibration detection information, and recognizing a fault symptom of the component based on an magnitude of increase in the vibration level of the component.

### INCORPORATION BY REFERENCE

The present application claims priority under 35 U.S.C. § 119 to Japanese Patent Application No. 2024-035509 filed on Mar. 8, 2024. The content of the application is incorporated herein by reference in its entirety.

### BACKGROUND OF THE INVENTION

### Field of the Invention

The present invention relates to a fault symptom diagnostic system and a fault symptom diagnostic method.

### Description of the Related Art

Conventionally, a diagnostic device has been proposed which determines abnormality of an engine component member based on a maximum amplitude value of sound wave signals sensed from acoustic emission waves generated from the engine component member during an engine operation (for example, see Japanese Patent No. 6373012).

In a case of diagnosing abnormality of a target member by measuring acoustic emission as in the diagnostic device of the related art described above, when the target member is formed of a plurality of components like an electric power transmission unit mounted on a vehicle for example, it is disadvantageous that a component with abnormality cannot be identified. Then, it is conceivable to identify the component with abnormality in the plurality of components by vibration measurement, however, in this case, since abnormality of the component is determined based on change in vibration from an initial stage after start of use of the target member, it is disadvantageous that a large-scale data processing system that deals with collection and storage of vibration measurement data is required.

An object of the present invention, which has been made in consideration of such a background, is to provide a fault symptom diagnostic system and a fault symptom diagnostic method capable of identifying a component with abnormality and diagnosing a symptom of a fault of a target member formed of a plurality of components while reducing measurement data to be collected.

### SUMMARY OF THE INVENTION

A first aspect for achieving the object is a fault symptom diagnostic system which monitors an operation state of a movable unit formed of a plurality of components and determines a fault symptom of the component, and the system includes: an acoustic emission detection information acquisition unit configured to acquire acoustic emission detection information indicating a status of acoustic emission waves generated from the movable unit as detected by an acoustic emission sensor; a vibration detection information acquisition unit configured to acquire vibration detection information indicating a status of vibrations generated in the component as detected by a vibration sensor; and a fault symptom recognition unit configured to recognize a fault symptom of the component based on the acoustic emission detection information and the vibration detection information. The fault symptom recognition unit executes first monitoring processing of repeatedly executing acoustic emission measuring processing of acquiring the acoustic emission detection information by the acoustic emission detection information acquisition unit and recognizing presence/absence of detection of the acoustic emission waves based on the acoustic emission detection information after start of use of the movable unit, and determining whether or not a first determination condition under which a number of times of detecting the acoustic emission waves by the acoustic emission measuring processing is equal to or larger than a predetermined number of times of determination is established, and when the first determination condition is established, ends the first monitoring processing and executes second monitoring processing of repeatedly executing vibration measuring processing of acquiring the vibration detection information by the vibration detection information acquisition unit and recognizing a vibration level of the component based on the vibration detection information, and recognizing a fault symptom of the component based on a magnitude of increase in the vibration level of the component.

In the fault symptom diagnostic system described above, the fault symptom recognition unit may repeatedly execute the acoustic emission measuring processing and determine whether or not a second determination condition under which a frequency of detecting the acoustic emission waves is equal to or higher than a predetermined determination frequency and the vibration level of the component recognized by the vibration measuring processing is equal to or higher than a predetermined determination level in the second monitoring processing, and when the second determination condition is established, may end the second monitoring processing and may execute third monitoring processing of repeatedly executing only the vibration measuring processing without executing the acoustic emission measuring processing and recognizing a fault symptom of the component based on the magnitude of increase in the vibration level of the component recognized by the vibration measuring processing.

In the fault symptom diagnostic system described above, in the first monitoring processing, the fault symptom recognition unit may execute the acoustic emission measuring processing during part of a predetermined measurement cycle for each measurement cycle.

A second aspect for achieving the object is a fault symptom diagnostic method which monitors an operation state of a movable unit formed of a plurality of components and determines a fault symptom of the component by a computer, and the method includes: an acoustic emission detection information acquisition step of acquiring acoustic emission detection information indicating a status of acoustic emission waves generated from the movable unit as detected by an acoustic emission sensor; a vibration detection information acquisition step of acquiring vibration detection information indicating a status of vibrations generated in the component as detected by a vibration sensor; and a fault symptom recognition step of recognizing a fault symptom of the component based on the acoustic emission detection information and the vibration detection information. The fault symptom recognition step executes first monitoring processing of repeatedly executing acoustic emission measuring processing of acquiring the acoustic emission detection information by the acoustic emission detection information acquisition step and recognizing presence/absence of detection of the acoustic emission waves based on the acoustic emission detection information after start of use of the movable unit, and determining whether or not a first determination condition under which a number of times of detecting the acoustic emission waves by the acoustic emission measuring processing is equal to or larger than a predetermined number of times of determination is established, and when the first determination condition is established, ends the first monitoring processing and executes second monitoring processing of repeatedly executing vibration measuring processing of acquiring the vibration detection information by the vibration detection information acquisition step and recognizing a vibration level of the component based on the vibration detection information, and recognizing a fault symptom of the component based on an magnitude of increase in the vibration level of the component.

### Advantageous Effect of Invention

According to the fault symptom diagnostic system and the fault symptom diagnostic method, a component with abnormality can be identified and a fault symptom of a target member formed of a plurality of components can be diagnosed while reducing measurement data to be collected.

### BRIEF DESCRIPTION OF THE DRAWINGS

FIG. 1 is an explanatory diagram of a configuration of a fault symptom diagnostic system;

FIG. 2 is an explanatory diagram of a mode of measuring acoustic emission waves and vibrations for a power transmission unit;

FIG. 3 is a timing chart of processing of monitoring an operation state of the power transmission unit;

FIG. 4 is a first flowchart of fault symptom diagnostic processing of the power transmission unit; and

FIG. 5 is a second flowchart of the fault symptom diagnostic processing of the power transmission unit.

### DETAILED DESCRIPTION OF THE INVENTION

### 1. Configuration of Fault Symptom Diagnostic System

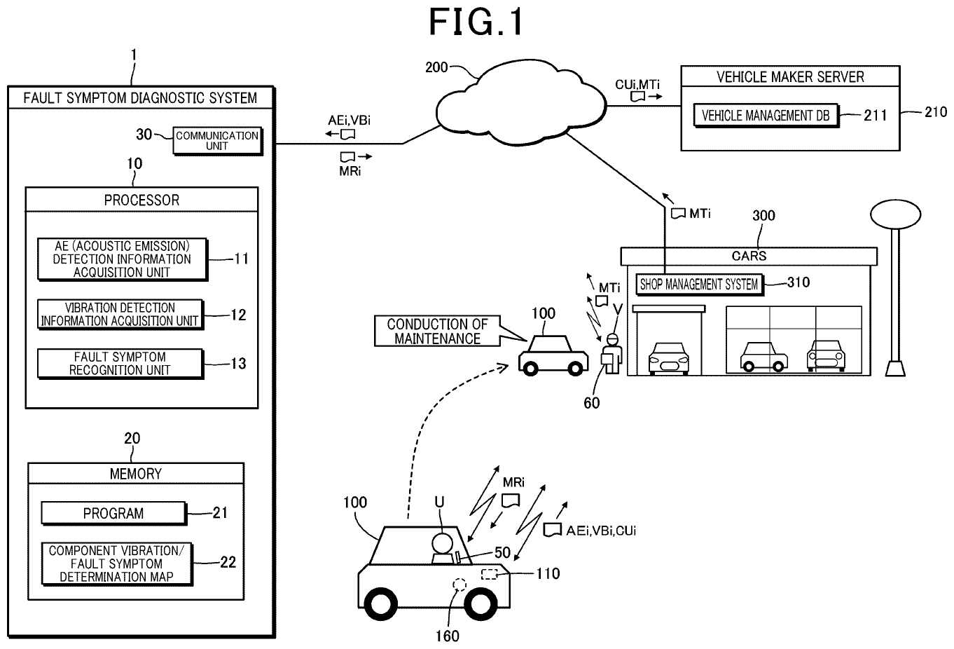

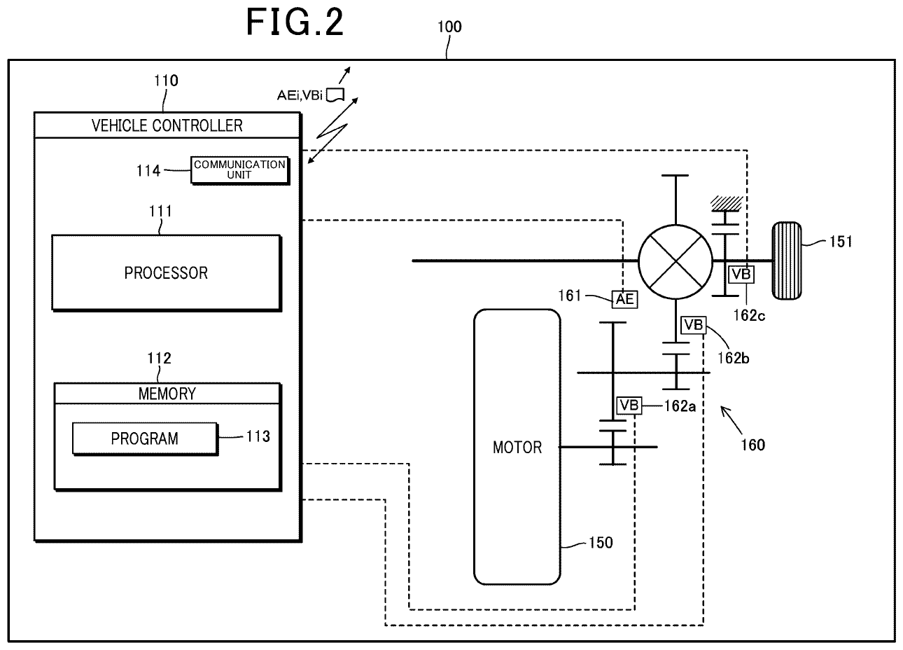

With reference to FIG. 1 and FIG. 2, a configuration of a fault symptom diagnostic system 1 of the present embodiment will be described. The fault symptom diagnostic system 1 performs processing of monitoring an operation state of a power transmission unit 160 provided in a vehicle 100 dealt at a car dealer 300, and diagnosing a fault symptom of a component forming the power transmission unit 160.

Dealings include sales of new cars, sales of used cars, lease contracts of vehicles, and the like. The power transmission unit 160 corresponds to a movable unit of the present disclosure. The fault symptom diagnostic system 1 is a computer system including a processor 10, a memory 20, a communication unit 30 (transmitter/receiver, circuit), and the like. The fault symptom diagnostic system 1 communicates with a vehicle controller 110 mounted on the vehicle 100, a user terminal 50 used by a user U, a vehicle maker server 210, and a shop management system 310 provided in the car dealer 300 or the like via a communication network 200 by the communication unit 30.

The vehicle 100 includes, as illustrated in FIG. 2, a motor 150 which is a drive source, the power transmission unit 160 which transmits driving power of the motor 150 to a wheel 151, and the vehicle controller 110 which controls an operation of the vehicle 100. In addition, the vehicle 100 includes an acoustic emission sensor 161 which detects acoustic emission waves generated when roughening, cracks, and flaking or the like are generated in the power transmission unit 160, and a plurality of vibration sensors 162 which detect vibrations generated in components (such as a bearing and a gear) forming the power transmission unit 160 for each component. FIG. 2 illustrates three vibration sensors 162a, 162b, and 162c as the vibration sensors 162.

Hereinafter, acoustic emission is also referred to as AE (Acoustic Emission). Further, the vibration sensors 162a, 162b, and 162c are referred to as the vibration sensors 162 altogether. The vibration sensors 162 detect the vibrations in three axial directions (a left-right direction, an up-down direction, and a front-rear direction). The AE sensor 161 and the vibration sensors 162 are connected with the vehicle controller 110, and detection signals of the AE sensor 161 and the vibration sensors 162 are input to the vehicle controller 110.

The vehicle controller 110 includes a processor 111, a memory 112, and a communication unit 114 (transmitter/receiver, circuit) or the like, and controls the operation of the vehicle 100 by reading and executing a program 113 for control of the vehicle controller 110 preserved in the memory 112 by the processor 111. The vehicle controller 110 transmits, by the communication unit 114, AE detection information AEi indicating a status of the AE waves as detected by the AE sensor 161 and vibration detection information VBi indicating a status of the vibrations of the components as detected by the vibration sensors 162 to the fault symptom diagnostic system 1.

In addition, the vehicle controller 110 transmits vehicle use information CUi indicating a status of use (such as a traveling distance, a traveling route, and a driving operation status) of the vehicle 100 to the vehicle maker server 210. The shop management system 310 and a person-in-charge-of-services terminal 60 used by a person V in charge of services of the car dealer 300 transmit maintenance information MTi indicating contents of maintenance of the vehicle 100 executed at the car dealer 300 to the vehicle maker server 210.

The vehicle maker server 210 receives the vehicle use information CUi transmitted from the vehicle 100 and the maintenance information MTi transmitted from the shop management system 310, and records the vehicle use information CUi and the maintenance information MTi in a vehicle management DB 211. Note that, while FIG. 1 illustrates one vehicle 100 and one car dealer 300 for convenience of description, actually, the vehicle maker server 210 communicates with a plurality of vehicles and shop management systems of car dealers, receives the vehicle use information CUi and the maintenance information MTi for each of the plurality of vehicles to be management targets, and records the information in the vehicle management DB 211.

In the memory 20 of the fault symptom diagnostic system 1, a program 21 for control of the fault symptom diagnostic system 1 and data of a component vibration/fault symptom determination map 22 in which the magnitude of increase in a vibration level of the components forming the power transmission unit 160 is made to correspond to a fault symptom level of the components are preserved. The component vibration/fault symptom determination map 22 is created by correspondence data of the magnitude of increase in the vibrations of the components measured in the past and the fault symptom level, and computer simulation or the like.

The processor 10 functions as an AE detection information acquisition unit 11, a vibration detection information acquisition unit 12, and a fault symptom recognition unit 13, by reading and executing the program 21. Processing executed by the AE detection information acquisition unit 11 corresponds to an AE detection information acquisition step in a fault symptom diagnostic method of the present disclosure, and processing executed by the vibration detection information acquisition unit 12 corresponds to a vibration detection information acquisition step in the fault symptom diagnostic method of the present disclosure. Processing executed by the fault symptom recognition unit 13 corresponds to a fault symptom recognition step in the fault symptom diagnostic method of the present disclosure.

The AE detection information acquisition unit 11 receives and acquires the AE detection information AEi from the vehicle 100 by communicating with the vehicle 100 by the communication unit 30. The vibration detection information acquisition unit 12 receives and acquires the vibration detection information VBi from the vehicle 100 by communicating with the vehicle 100 by the communication unit 30.

The fault symptom recognition unit 13 recognizes the fault symptom of the components forming the power transmission unit 160 by monitoring the detection status of the AE waves generated from the power transmission unit 160 of the vehicle 100 and the vibration status of the components of the power transmission unit 160, based on the AE detection information AEi acquired by the AE detection information acquisition unit 11 and the vibration detection information VBi acquired by the vibration detection information acquisition unit 12.

Note that, while FIG. 1 illustrates a situation where the fault symptom diagnostic system 1 diagnoses the fault symptom of the components forming the power transmission unit 160 for one vehicle 100 for the convenience of the description, actually, the fault symptom diagnostic system 1 communicates with a plurality of vehicles and diagnoses faults of the components for each power transmission unit mounted on each vehicle.

In addition, while the fault symptom diagnostic system 1 receives the AE detection information AEi and the vibration detection information VBi by communicating with the vehicle 100 in FIG. 1, the AE detection information AEi and the vibration detection information VBi may be transmitted from the vehicle 100 to the vehicle maker server 210 and the AE detection information AEi and the vibration detection information VBi may be recorded in the vehicle management DB 211. In this case, the fault symptom diagnostic system 1 accesses the vehicle maker server 210, and receives the AE detection information AEi and the vibration detection information VBi recorded in the vehicle management DB 211.

### 2. Fault Symptom Diagnostic Processing

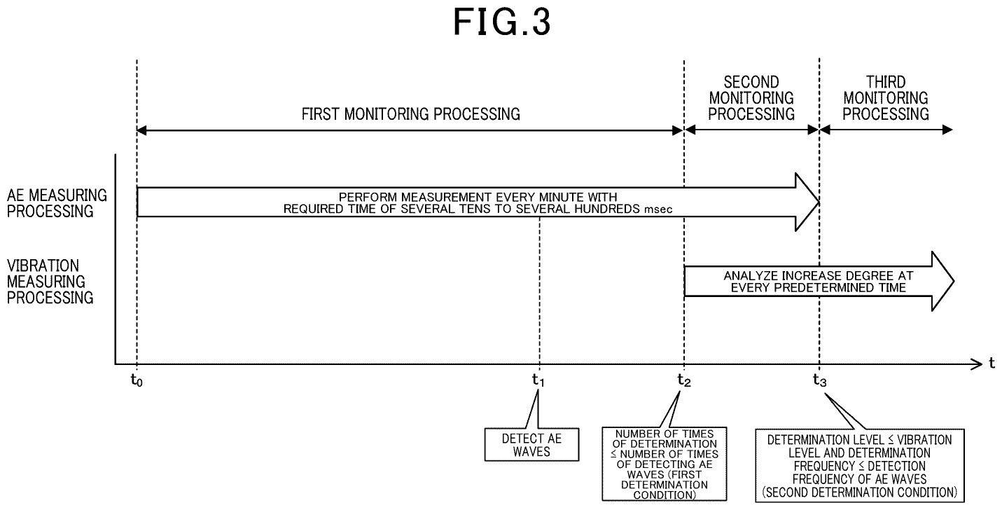

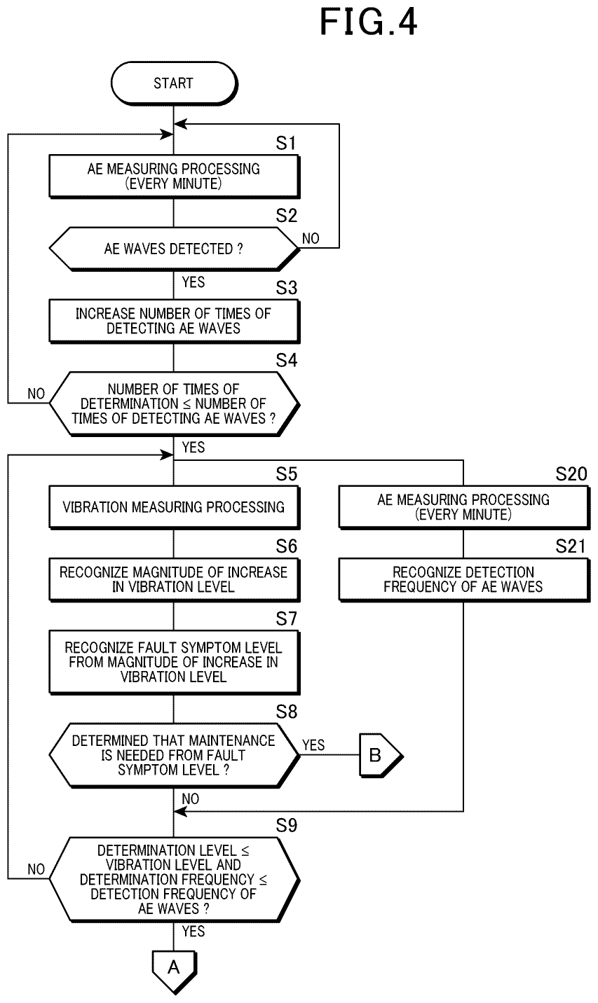

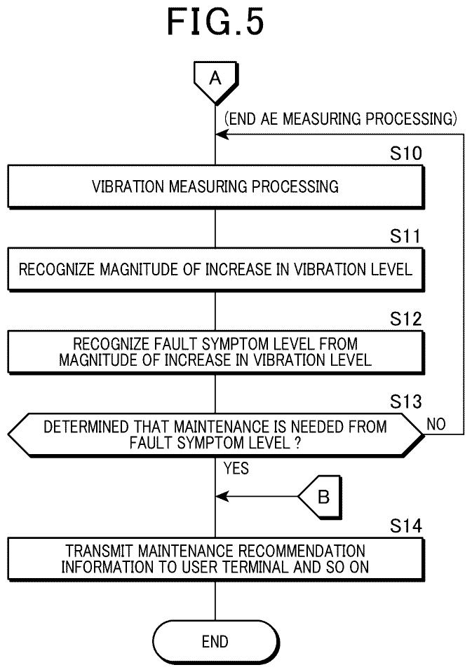

With reference to a timing chart illustrated in FIG. 3, a procedure of the fault symptom diagnostic processing of the component forming the power transmission unit 160 of the vehicle 100 executed by the fault symptom diagnostic system 1 will be described according to flowcharts illustrated in FIG. 4 and FIG. 5.

FIG. 3 illustrates, by a time base t, execution timings of AE measuring processing of measuring presence/absence of the AE waves generated from the power transmission unit 160 of the vehicle 100 based on the AE detection information AEi acquired by the AE detection information acquisition unit 11 and vibration measuring processing of measuring the vibrations of the components forming the power transmission unit 160 of the vehicle 100 based on the vibration detection information VBi acquired by the vibration detection information acquisition unit 12.

In step S1 in FIG. 4, the fault symptom recognition unit 13 acquires the AE detection information AEi from the vehicle 100 by the AE detection information acquisition unit 11, and executes the AE measuring processing every minute (corresponding to a measuring cycle of the present disclosure). In following step S2, the fault symptom recognition unit 13 advances processing to step S3 when the AE waves are detected by the AE measuring processing, and advances the processing to step S1 when the AE waves are not detected by the AE measuring processing.

In step S3, the fault symptom recognition unit 13 increases (+1) a number of times of detecting the AE waves, and whether or not the number of times of detecting the AE waves is equal to or larger than a number of times of determination is determined in next step S4. Then, the fault symptom recognition unit 13 advances the processing to step S5 and step S20 when the number of times of detecting the AE waves is equal to or larger than the number of times of determination, and advances the processing to step S1 when the number of times of detecting the AE waves is smaller than the number of times of determination.

By the processing (first monitoring processing) in steps S1-S4, as illustrated in FIG. 3, from t0 at which monitoring of the power transmission unit 160 of the vehicle 100 is started through t1 at which the AE waves are detected for the first time to t2 at which the number of times of detecting the AE waves becomes equal to or larger than the number of times of determination, only the AE measuring processing is executed, and the vibration measuring processing is not executed. Then, since the AE measuring processing is executed every minute and the time required for the AE measuring processing is about several tens to several hundreds msec, a data amount to be collected, stored and processed is small. Therefore, there is no need to prepare a large-scale data processing system that deals with collection, storage, and processing of a large amount of data.

The fault symptom recognition unit 13 executes the processing in steps S5-S8 and the processing in steps S20-S21 in parallel. The processing in steps S5-S8 is executed for each component for which the vibrations are individually detected by the plurality of vibration sensors 162 provided in the power transmission unit 160. In step S5, the fault symptom recognition unit 13 acquires the vibration detection information VBi from the vehicle 100 by the vibration detection information acquisition unit 12, and executes the vibration measuring processing. In following step S6, the fault symptom recognition unit 13 recognizes the magnitude of increase in the vibration level of the component from the time (t2 in FIG. 3) when vibration measurement is started.

In next step S7, the fault symptom recognition unit 13 applies the magnitude of increase in the vibration level of the component to the component vibration/fault symptom determination map 22 (see FIG. 1), and recognizes the fault symptom level of the component. In following step S8, the fault symptom recognition unit 13 determines necessity of maintenance of the component from the fault symptom level of the component. Then, when the maintenance of the component is needed, the fault symptom recognition unit 13 advances the processing to step S14 in FIG. 5, transmits maintenance recommendation information MRi that recommends conduction of the maintenance to the user terminal 50, and thus urges the user U to receive the maintenance of the power transmission unit 160.

Note that the maintenance recommendation information MRi may be transmitted to the vehicle controller 110 to display an image that recommends the maintenance at a display device provided in the vehicle 100. Alternatively, the maintenance recommendation information MRi may be transmitted to the shop management system 310 to have the person V in charge of services contact the user U to recommend the maintenance.

On the other hand, when it is determined that the maintenance of the component is not needed yet, the fault symptom recognition unit 13 advances the processing to step S9. In addition, the fault symptom recognition unit 13 acquires the AE detection information AEi from the vehicle 100 by the AE detection information acquisition unit 11 and performs AE measurement every minute in step S20. In following step S21, the fault symptom recognition unit 13 recognizes a detection frequency of the AE waves by the AE measurement (a ratio of the number of times of the AE measurement in which the AE waves are detected in the predetermined number of times of the AE measurement), and advances the processing to step S9.

In step S9, the fault symptom recognition unit 13 determines whether or not a second determination condition under which the measured vibration level of the component is equal to or higher than a determination level and the detection frequency of the AE waves is equal to or higher than a determination frequency is established. Then, the fault symptom recognition unit 13 advances the processing to step S10 in FIG. 5 when the second determination condition is established, and advances the processing to step S5 when the second determination condition is not established.

By the processing (second monitoring processing) in steps S5-S9 and steps S20-S21, as illustrated in FIG. 3, the vibration measuring processing is started at t2 at which the number of times of detecting the AE waves becomes equal to or larger than the number of times of determination and it is estimated that degradation of the power transmission unit 160 has advanced. Then, the AE measuring processing and the vibration measuring processing are executed during a period of t2-t3, and the detection frequency of the AE waves by the AE measuring processing and the vibration level of the component of the power transmission unit 160 by the vibration measuring processing are monitored.

In the second monitoring processing, the component can be identified and the fault symptom of the component forming the power transmission unit 160 can be recognized by the vibration measuring processing. In addition, by the detection frequency of the AE waves by the AE measuring processing, it can be recognized that a possibility of fault occurrence of the power transmission unit 160 is increasing.

In step S10 in FIG. 5, the fault symptom recognition unit 13 acquires the vibration detection information VBi from the vehicle 100 by the vibration detection information acquisition unit 12, and executes the vibration measuring processing. In following step S11, the fault symptom recognition unit 13 recognizes the magnitude of increase in the vibration level of the component from the time (t2 in FIG. 3) when the vibration measuring processing is started.

In next step S12, the fault symptom recognition unit 13 applies the magnitude of increase in the vibration level of the component to the component vibration/fault symptom determination map 22 (see FIG. 1), and recognizes the fault symptom level of the component. In following step S13, the fault symptom recognition unit 13 determines the necessity of the maintenance of the component from the fault symptom level of the component.

Then, when the maintenance of the component is needed, the fault symptom recognition unit 13 advances the processing to step S14, transmits the maintenance recommendation information MRi that recommends conduction of the maintenance to the user terminal 50, and thus urges the user U to conduct the maintenance of the power transmission unit 160. On the other hand, when it is determined that the maintenance of the component is not needed, the fault symptom recognition unit 13 advances to step S10, and continues monitoring of the vibration level of the component forming the power transmission unit 160.

By the processing (third monitoring processing) in step S10-S13, as illustrated in FIG. 3, when it can be estimated, by the establishment of the second determination condition, that a state where the possibility of the fault occurrence of the power transmission unit 160 is high continues due to increase in the detection frequency of the AE waves and the possibility of the fault occurrence of the component has increased due to increase in the vibration level, the AE measuring processing is ended, and monitoring is continued only by the vibration measuring processing.

### 3. Other Embodiments

While the embodiment described above exemplifies the power transmission unit 160 provided in the vehicle 100 as a movable unit of the present embodiment, the movable unit of the present embodiment may be a movable unit for which the AE waves and the vibrations can be measured. For example, it may be a moving body (such as an airplane or a ship) other than a vehicle.

In the embodiment described above, as illustrated in FIG. 3, the operation state of the power transmission unit 160 is monitored by starting the first monitoring processing of performing only the AE measurement without performing the vibration measurement from t0 at which the power transmission unit 160 is started to be used, switching to the second monitoring processing of performing the vibration measurement and the AE measurement at t2 at which the first determination condition is established, and switching to the third monitoring processing of performing only the vibration measurement without performing the AE measurement at t3 at which the second determination condition is established. As another embodiment, the operation state of the power transmission unit 160 may be monitored by continuing the second monitoring processing without determining the second determination condition after switching from the first monitoring processing to the second monitoring processing.

The embodiment described above illustrates an example in which the fault symptom diagnostic system of the present disclosure is formed of the fault symptom diagnostic system 1 which communicates with the vehicle 100. As another configuration, the fault symptom diagnostic system of the present disclosure may be provided in the vehicle 100. Further, the fault symptom diagnostic system of the present disclosure may be formed as a part of functions of the vehicle maker server 210 or the shop management system 310.

Note that FIG. 1 is a schematic diagram in which the configuration of the fault symptom diagnostic system 1 is divided depending on main processing contents and illustrated in order to facility understanding of the present invention, and the fault symptom diagnostic system 1 may be configured by other divisions. In addition, the processing of each element may be executed by one hardware unit, or may be executed by a plurality of hardware units. Further, the processing by each element illustrated in FIG. 4 and FIG. 5 may be executed by one program, or may be executed by a plurality of programs.

### 4. Configurations Supported by Embodiment Described Above

The embodiment described above is a specific example of the following configurations.

(Configuration 1) A fault symptom diagnostic system which monitors an operation state of a movable unit formed of a plurality of components and determines a fault symptom of the component, the system including: an acoustic emission detection information acquisition unit configured to acquire acoustic emission detection information indicating a status of acoustic emission waves generated from the movable unit as detected by an acoustic emission sensor; a vibration detection information acquisition unit configured to acquire vibration detection information indicating a status of vibrations generated in the component as detected by a vibration sensor; and a fault symptom recognition unit configured to recognize a fault symptom of the component based on the acoustic emission detection information and the vibration detection information, wherein the fault symptom recognition unit executes first monitoring processing of repeatedly executing acoustic emission measuring processing of acquiring the acoustic emission detection information by the acoustic emission detection information acquisition unit and recognizing presence/absence of detection of the acoustic emission waves based on the acoustic emission detection information after start of use of the movable unit, and determining whether or not a first determination condition under which a number of times of detecting the acoustic emission waves by the acoustic emission measuring processing is equal to or larger than a predetermined number of times of determination is established, and when the first determination condition is established, ends the first monitoring processing and executes second monitoring processing of repeatedly executing vibration measuring processing of acquiring the vibration detection information by the vibration detection information acquisition unit and recognizing a vibration level of the component based on the vibration detection information, and recognizing a fault symptom of the component based on an magnitude of increase in the vibration level of the component.

According to the fault symptom diagnostic system of configuration 1, by performing only the acoustic emission measuring processing by the first monitoring processing after the start of use of the movable unit until it is estimated that a possibility of a fault of the movable unit has increased to some extent, loads of collecting and processing measurement data can be reduced compared to a case of performing the vibration measuring processing from the time of the start of use of the movable unit. Then, by performing the vibration measuring processing after the first determination condition is established, the component can be identified and the fault symptom can be diagnosed.

(Configuration 2) The fault symptom diagnostic system according to configuration 1, wherein the fault symptom recognition unit repeatedly executes the acoustic emission measuring processing and determines whether or not a second determination condition under which a frequency of detecting the acoustic emission waves is equal to or higher than a predetermined determination frequency and the vibration level of the component recognized by the vibration measuring processing is equal to or higher than a predetermined determination level in the second monitoring processing, and when the second determination condition is established, ends the second monitoring processing and executes third monitoring processing of repeatedly executing only the vibration measuring processing without executing the acoustic emission measuring processing and recognizing a fault symptom of the component based on the magnitude of increase in the vibration level of the component recognized by the vibration measuring processing.

According to the fault symptom diagnostic system of configuration 2, when it is estimated that the possibility that the degradation of the movable unit has advanced further increases by establishment of the second determination condition, by ending the acoustic emission measuring processing and switching to the third monitoring processing of executing only the vibration measuring processing, the loads of collecting and processing the measurement data can be reduced.

(Configuration 3) The fault symptom diagnostic system according to configuration 1 or configuration 2, wherein in the first monitoring processing, the fault symptom recognition unit executes the acoustic emission measuring processing during part of a predetermined measurement cycle for each measurement cycle.

According to the fault symptom diagnostic system of configuration 3, by setting an interval of executing the acoustic emission measuring processing to be longer than the time required for the acoustic emission measuring processing, the acoustic emission measuring processing is intermittently performed and the loads of data collection and data processing by the acoustic emission measuring processing can be reduced.

(Configuration 4) A fault symptom diagnostic method which monitors an operation state of a movable unit formed of a plurality of components and determines a fault symptom of the component by a computer, the method including: an acoustic emission detection information acquisition step of acquiring acoustic emission detection information indicating a status of acoustic emission waves generated from the movable unit as detected by an acoustic emission sensor; a vibration detection information acquisition step of acquiring vibration detection information indicating a status of vibrations generated in the component as detected by a vibration sensor; and a fault symptom recognition step of recognizing a fault symptom of the component based on the acoustic emission detection information and the vibration detection information, wherein the fault symptom recognition step executes first monitoring processing of repeatedly executing acoustic emission measuring processing of acquiring the acoustic emission detection information by the acoustic emission detection information acquisition step and recognizing presence/absence of detection of the acoustic emission waves based on the acoustic emission detection information after start of use of the movable unit, and determining whether or not a first determination condition under which a number of times of detecting the acoustic emission waves by the acoustic emission measuring processing is equal to or larger than a predetermined number of times of determination is established, and when the first determination condition is established, ends the first monitoring processing and executes second monitoring processing of repeatedly executing vibration measuring processing of acquiring the vibration detection information by the vibration detection information acquisition step and recognizing a vibration level of the component based on the vibration detection information, and recognizing a fault symptom of the component based on an magnitude of increase in the vibration level of the component.

By executing the fault symptom diagnostic method of configuration 4 by a computer, effects similar to that of the fault symptom diagnostic system of configuration 1 can be obtained.

### REFERENCE SIGNS LIST

1 . . . fault symptom diagnostic system, 10 . . . processor, 11 . . . AE detection information acquisition unit, 12 . . . vibration detection information acquisition unit, 13 . . . fault symptom recognition unit, 20 . . . memory, 21 . . . program, 22 . . . component vibration/fault symptom determination map, 30 . . . communication unit, 50 . . . user terminal, 60 . . . person-in-charge-of-services terminal, 100 . . . vehicle, 110 . . . vehicle controller, 160 . . . power transmission unit, 161 . . . AE sensor, 162 . . . vibration sensor, 200 . . . communication network, 210 . . . vehicle maker server, 211 . . . vehicle management DB, 300 . . . car dealer, 310 . . . shop management system, U . . . user, V . . . person in charge of services.

1. A fault symptom diagnostic system which monitors an operation state of a movable unit formed of a plurality of components and determines a fault symptom of the component, the system comprising:
an acoustic emission detection information acquisition unit configured to acquire acoustic emission detection information indicating a status of acoustic emission waves generated from the movable unit as detected by an acoustic emission sensor;
a vibration detection information acquisition unit configured to acquire vibration detection information indicating a status of vibrations generated in the component as detected by a vibration sensor; and
a fault symptom recognition unit configured to recognize a fault symptom of the component based on the acoustic emission detection information and the vibration detection information,
wherein the fault symptom recognition unit
executes first monitoring processing of repeatedly executing acoustic emission measuring processing of acquiring the acoustic emission detection information by the acoustic emission detection information acquisition unit and recognizing presence/absence of detection of the acoustic emission waves based on the acoustic emission detection information after start of use of the movable unit, and determining whether or not a first determination condition under which a number of times of detecting the acoustic emission waves by the acoustic emission measuring processing is equal to or larger than a predetermined number of times of determination is established, and
when the first determination condition is established, ends the first monitoring processing and executes second monitoring processing of repeatedly executing vibration measuring processing of acquiring the vibration detection information by the vibration detection information acquisition unit and recognizing a vibration level of the component based on the vibration detection information, and recognizing a fault symptom of the component based on an magnitude of increase in the vibration level of the component.

2. The fault symptom diagnostic system according to claim 1,
wherein the fault symptom recognition unit
repeatedly executes the acoustic emission measuring processing and determines whether or not a second determination condition under which a frequency of detecting the acoustic emission waves is equal to or higher than a predetermined determination frequency and the vibration level of the component recognized by the vibration measuring processing is equal to or higher than a predetermined determination level in the second monitoring processing, and
when the second determination condition is established, ends the second monitoring processing and executes third monitoring processing of repeatedly executing only the vibration measuring processing without executing the acoustic emission measuring processing and recognizing a fault symptom of the component based on the magnitude of increase in the vibration level of the component recognized by the vibration measuring processing.

3. The fault symptom diagnostic system according to claim 1,
wherein in the first monitoring processing, the fault symptom recognition unit executes the acoustic emission measuring processing during part of a predetermined measurement cycle for each measurement cycle.

4. A fault symptom diagnostic method which monitors an operation state of a movable unit formed of a plurality of components and determines a fault symptom of the component by a computer, the method comprising:
an acoustic emission detection information acquisition step of acquiring acoustic emission detection information indicating a status of acoustic emission waves generated from the movable unit as detected by an acoustic emission sensor;
a vibration detection information acquisition step of acquiring vibration detection information indicating a status of vibrations generated in the component as detected by a vibration sensor; and
a fault symptom recognition step of recognizing a fault symptom of the component based on the acoustic emission detection information and the vibration detection information,
wherein the fault symptom recognition step
executes first monitoring processing of repeatedly executing acoustic emission measuring processing of acquiring the acoustic emission detection information by the acoustic emission detection information acquisition step and recognizing presence/absence of detection of the acoustic emission waves based on the acoustic emission detection information after start of use of the movable unit, and determining whether or not a first determination condition under which a number of times of detecting the acoustic emission waves by the acoustic emission measuring processing is equal to or larger than a predetermined number of times of determination is established, and
when the first determination condition is established, ends the first monitoring processing and executes second monitoring processing of repeatedly executing vibration measuring processing of acquiring the vibration detection information by the vibration detection information acquisition step and recognizing a vibration level of the component based on the vibration detection information, and recognizing a fault symptom of the component based on an magnitude of increase in the vibration level of the component.
